(19) United States
(12) Patent Application Publication
(10) Pub. No.: US 2022/0287157 A1
(43) Pub. Date: Sep. 8, 2022

(54) ELECTRIC HEATER

(71) Applicant: I.R.C.A..S.P.A.INDUSTRIA RESISTENZE CORAZZATE E AFFINI, Vittorio Veneto (IT)

(72) Inventors: Ivano BOLZAN, Treviso (IT); Mario EUSEBIO, Pordenone (IT); Stefano ZANELLA, Montebelluna (IT); Federico ZOPPAS, Treviso (IT)

(21) Appl. No.: 17/629,393

(22) PCT Filed: Jul. 27, 2020
(86) PCT No.: PCT/IB2020/057058

§ 371 Date: Jan. 23, 2022

(30) Foreign Application Priority Data
Jul. 25, 2019 (IT) 102019000012903

(51) Int. Cl. H05B 3/48

(52) U.S. Cl. CPC H05B 3/48; H05B 2203/02; H05B 2203/017; H05B 3/141

(57) ABSTRACT

An electric heater (1) comprising:—at least one armored tubular cartridge (2) comprising at least one PTC resistor (3) therein; —a block of aluminum (4), or alloys thereof, overmolded by die-casting around said at least one armored tubular cartridge (2); wherein a coating layer in plastic material (5) is provided, applied around said block of aluminum (4).

### FIELD OF THE INVENTION

The present invention relates to an electric heater for any application in which it is necessary to ensure an optimal heat transmission, ensuring a high level of safety on the maximum temperature reached by the system.

### BACKGROUND ART

Electric heaters comprising armored tubular cartridges and/or resistors, comprising at least one resistive wire embedded in magnesium oxide, are available on the market.

A first disadvantage is represented by the fact that the temperature adjustment is carried out by means of additional components, such as thermostats or thermocouples.

A second disadvantage is represented by the fact that, often, the heat exchange of these armored tubular cartridges with other components, adhering externally to the cartridge, is not optimal due to the presence of air between the component in question and the armored tubular cartridge.

The need is therefore felt for an electric heater which allows overcoming the background art.

### SUMMARY OF THE INVENTION

It is an object of the present invention to make an electric heater which is simpler from the constructive and functional point of view.

It is another object of the present invention to make an electric heater which optimizes the heat exchange between the armored tubular cartridge with the external component to which it is associated.

It is a further object of the invention to make an electric heater which ensures a maximum system temperature without the possibility of error even in the event of a malfunction of possible temperature sensors.

It is another object of the invention to make an electric heater which allows reducing energy consumption by modulating the power with the operating temperature.

The present invention achieves at least one of such objects and other objects which will become apparent in light of the present description, by an electric heater comprising:
at least one armored tubular cartridge comprising at least one PTC resistor therein;
a block of aluminum, or alloys thereof, overmolded by die-casting around said at least one armored tubular cartridge;
in which there is provided a coating layer in plastic material, applied around said block of aluminum.

According to an aspect, the invention also comprises a production process of the aforesaid electric heater comprising the following steps:
providing at least one armored tubular cartridge comprising at least one PTC resistor therein;
overmolding by die-casting a block of aluminum, or alloys thereof, around said at least one armored tubular cartridge;
applying plastic material around said block of aluminum (4) to produce a coating layer.

In the solution of the invention, at least one armored tubular cartridge is placed inside the aluminum die-cast, generating heat by means of the application of at least one PTC stone.

By virtue of this cartridge, no further temperature control systems are required since, by virtue of the PTC effect of the stone, the latter will never exceed the pre-selected temperature threshold.

In Positive Temperature Coefficient (PTC) resistors, in fact, the value of the resistance increases as the temperature increases, whereby there will be a limitation of the maximum current flowing in the circuit, ensuring that a predetermined maximum temperature is not exceeded.

Among the advantages of the solution of the invention there are:
high production at low cost by virtue of the die-casting process which is now at an advanced level of industrialization;
improvement of the heat exchange of the armored tubular cartridge with the die-cast aluminum on the outside thereof, since in the die-casting process the aluminum solidifies under pressure directly around the cartridge, avoiding the formation of air bubbles which would decrease the thermal efficiency of the system, since air is a thermal insulator;
there is no need to electrically insulate the block of aluminum;
when the PTC resistor is used to heat up a liquid, for example water, the PTC resistor will not be damaged after the liquid is evaporated;
the PTC resistor has a long operating life, under normal circumstances the service life is up to 10 years.

Advantageously, the electric heater of the invention can be used in domestic or industrial evaporators, or in coffee machines.

Further features and advantages of the invention will become more apparent in the light of the detailed description of exemplary but not exclusive embodiments.

The dependent claims describe particular embodiments of the invention.

### BRIEF DESCRIPTION OF THE DRAWINGS

In the description of the invention, reference is made to the accompanying drawings, which are provided by way of non-limiting example, in which:

FIG. 1 shows a partially sectional perspective view of components of a first embodiment of an electric heater according to the invention;

FIG. 2 shows a cross-section of the view of FIG. 1;

FIG. 3 shows a sectional view of said first embodiment of the electric heater according to the invention;

FIG. 4 shows a side view of components of a second embodiment of the electric heater according to the invention;

FIG. 5 shows a side view of components of a third embodiment of the electric heater according to the invention;

FIG. 6 shows a side view of components of a fourth embodiment of the electric heater according to the invention;

FIG. 7 shows a sectional view of a variant of the electric heater according to the invention;

FIG. 8 shows a sectional view of a further variant of the electric heater according to the invention.

The same elements or functionally equivalent elements have the same reference numerals.

### DESCRIPTION OF EXEMPLARY EMBODIMENTS OF THE INVENTION

With reference to the Figures, an electric heater 1 of the present invention is described, comprising in all the embodiments thereof:
at least one armored tubular cartridge 2 comprising at least one PTC (Positive Temperature Coefficient) resistor 3 therein;
a block or element of aluminum 4, or alloys thereof, overmolded by die-casting around the at least one armored tubular cartridge 2.

Therefore, the block of aluminum 4 is adjacent, preferably perfectly adjacent, externally to the one or more armored tubular cartridges 2.

Advantageously, the block of aluminum 4 completely surrounds a single armored tubular cartridge (FIG. 3) or two or more armored tubular cartridges 2 (FIGS. 7 and 8). From the block of aluminum 4 only the electrical supply cables 9, which feed the at least one armored tubular cartridge 2, can protrude. In the case of more than one armored tubular cartridge 2, a pair of electrical supply cables 9 is provided for each armored tubular cartridge.

Advantageously, to protect the block of aluminum 4, a coating layer in plastic material 5 is also provided, for example in Polyethylene or Polyamide or Teflon, applied, for example overmolded, around the block of aluminum 4. Therefore, said coating layer 5 is adjacent, preferably perfectly adjacent, externally to the block of aluminum 4.

The plastic coating layer 5 can have a thickness of about 0,1-5 mm.

Preferably, inside each armored tubular cartridge 2 there is provided a plurality of PTC resistors 3, preferably of ceramic material, connected in sequence to one another along the entire armored tubular cartridge 2. Such PTC resistors are, for example, in the form of stones, substantially in the shape of a flat rectangular parallelepiped, connected the one to the next one in series at end faces having a much smaller area with respect to the areas of the other faces of the stones.

Said PTC resistors are inserted between two heat sinks or electrodes 8 made of aluminum, or alloys thereof. Each aluminum heat sink or electrode 8 is connected to a respective electrical supply cable 9 which protrudes from one end of the respective armored tubular cartridge 2.

The assembly defined by the aluminum heat sinks or electrodes 8 and by the PTC resistors 3 is surrounded by a layer of insulating material 10, preferably powdered magnesium oxide or polyimide, externally delimited by a metal sheath 11, preferably in steel. Therefore, the block of aluminum 4 is overmolded by die-casting around the metal sheath 11.

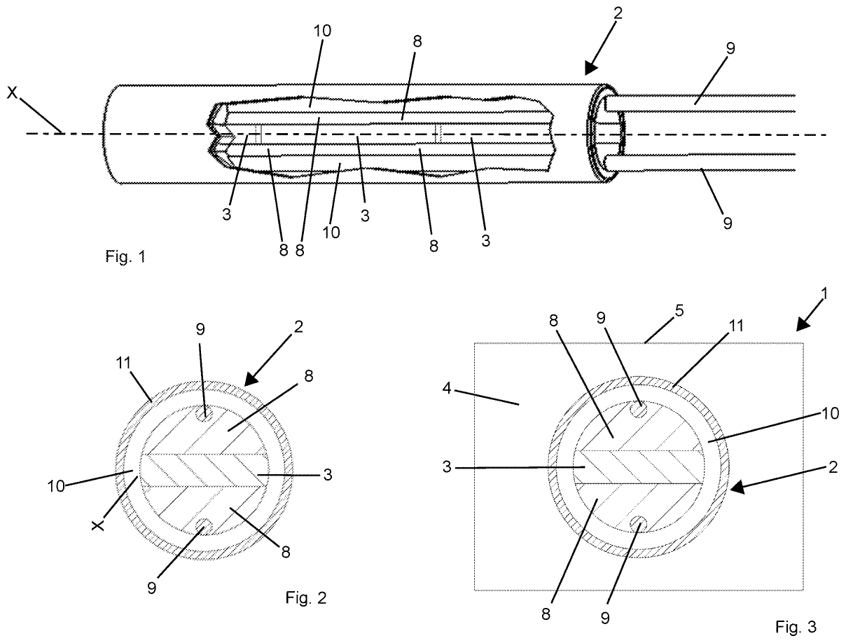

In a first embodiment shown in FIGS. 1-3, the armored tubular cartridge 2 exclusively defines a straight longitudinal axis X.

For example, three PTC resistors 3 are provided in series inside the armored tubular cartridge 2. However, the number of PTC resistors 3 can be less or greater than three.

In the variant shown in FIG. 3, the shape of the armored tubular cartridge 2 is cylindrical, with the metal sheath 11 having a circular section and the two heat sinks 8 having a semi-cylindrical shape and being arranged opposite to each other, while the cross-section of the block of aluminum 4 surrounding the cartridge 2 is quadrangular.

Any other shape of the armored tubular cartridge 2 and of the block of aluminum 4 can be provided. It is not excluded that both the armored tubular cartridge 2 and the die-cast block of aluminum 4 are provided having the same cross-sectional shape.

A variant of this first embodiment provides that the armored tubular cartridge 2 exclusively defines a curvilinear longitudinal axis, rather than a straight one.

In this first embodiment, a single armored tubular cartridge 2 can be provided, or two or more armored tubular cartridges, equal or different from one another, can be provided, inside the die-cast block of aluminum.

Other variants of the electric heater of the invention provide that the at least one armored tubular cartridge 2 comprises more than one stretch or portion; in which at least one first stretch 6 defines a straight longitudinal axis and at least one second stretch 7 defines a curvilinear axis.

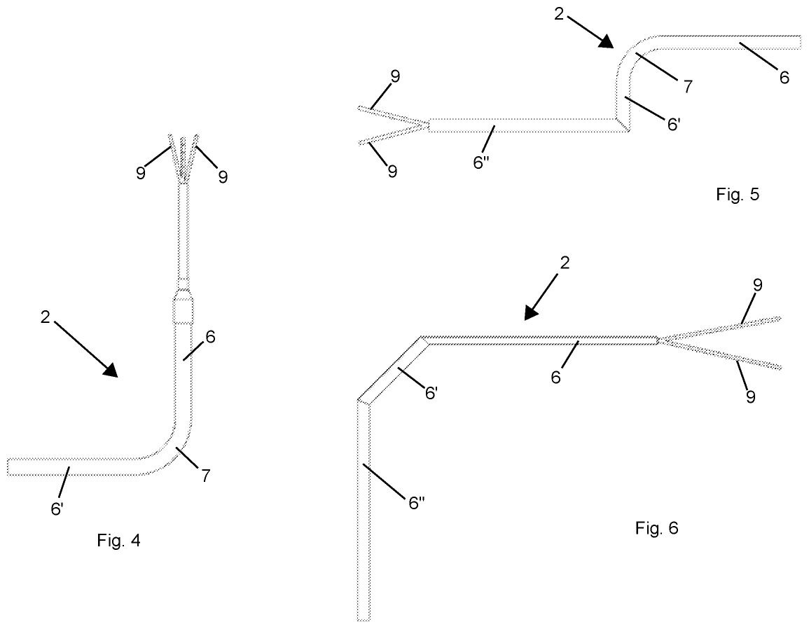

In a second embodiment shown in FIG. 4, the armored tubular cartridge 2 comprises, or consists of, two straight stretches 6, 6′ joined together by at least one curvilinear stretch 7, preferably by only one curvilinear stretch 7. Preferably the two stretches 6, 6′ are perpendicular to each other.

In a third embodiment shown in FIG. 5, the armored tubular cartridge 2 comprises two straight stretches 6, 6′ joined together by at least one curvilinear stretch 7, preferably by only one curvilinear stretch 7. A further straight stretch 6″ is provided in sequence to the straight stretch 6′.

Preferably the stretches 6, 6′ are perpendicular to each other and, possibly, also the stretches 6′, 6″ are perpendicular to each other and, therefore, the stretches 6 and 6″ are parallel to each other.

A variant of this third embodiment, not shown, can include the presence of a further curvilinear stretch between the straight stretch 6′ and the straight stretch 6″, said further curvilinear stretch having a radius of curvature opposite to the curvilinear stretch 7.

Another variant of this third embodiment, not shown, can instead include the presence of two curvilinear stretches, with opposite radius of curvature, between the straight stretch 6 and the straight stretch 6″. In this latter case, the straight stretch 6′ is not provided.

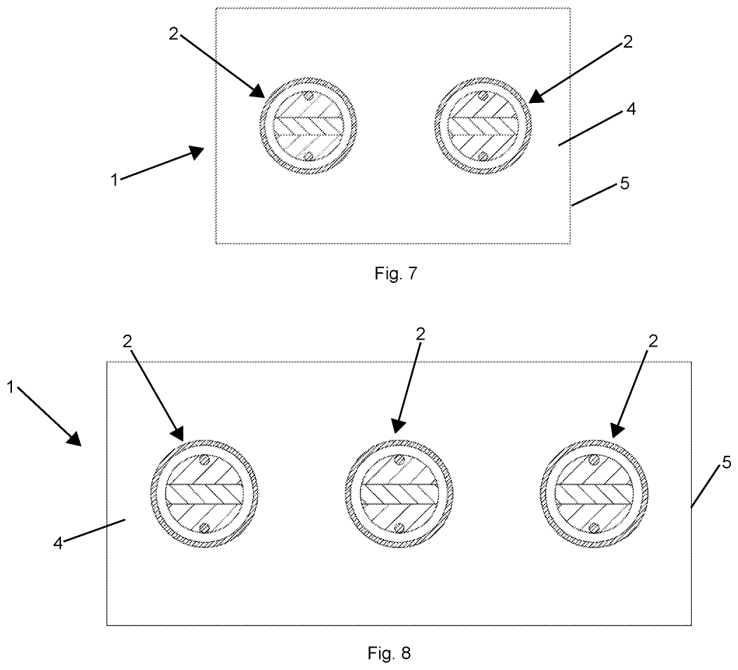

In a fourth embodiment shown in FIG. 6, the armored tubular cartridge 2 comprises at least two straight stretches 6, 6′; each stretch 6, 6′ defining a respective straight longitudinal axis and in which the straight longitudinal axes define a broken line.

In the variant shown in FIG. 6 three straight stretches 6, 6′, 6″ are provided.

Preferably, but not necessarily, the straight stretches 6 and 6″ are perpendicular to each other, while the intermediate straight stretch 6′ is inclined by an acute angle, preferably between 30° and 60°, for example 45°, with respect to one of the two stretches 6, 6″.

FIGS. 4, 5 and 6 do not show the block of aluminum 4 surrounding the armored tubular cartridge 2.

Even in the second, third and fourth embodiments, a single armored tubular cartridge 2 can be provided, or two or more armored tubular cartridges, equal or different from one another, can be provided, inside the die-cast block of aluminum.

In the embodiments of the electric heater of the invention in which at least two stretches are provided having a longitudinal axis different from each other, each stretch 6, 6′, 6″, 7 comprises at least one PTC resistor 3 therein.

In particular, each straight stretch 6, 6′, 6″ comprises a plurality of PTC resistors 3, preferably in ceramic material, connected in sequence to one another along the entire stretch and inserted between two heat sinks or electrodes 8 in aluminum, or alloys thereof, each aluminum heat sink or electrode 8 being connected to a respective electrical supply cable 9 which protrudes from one end of the armored tubular cartridge 2.

In each curvilinear stretch 7, instead, a single PTC resistor 3 can be provided, substantially flat in shape and having a curvilinear axis, or a plurality of PTC resistors can be provided, substantially flat in shape and having a straight axis but a much shorter longitudinal extension with respect to the single PTC resistor with a curvilinear axis. In the latter case, the PTC resistors are arranged with the straight axes thereof incident to each other along the curvilinear stretch 7.

Also in the curvilinear stretches 7, the single PTC resistor or the plurality of PTC resistors are inserted between two heat sinks or electrodes 8 in aluminum, or alloys thereof, each aluminum heat sink or electrode 8 being connected to a respective electrical supply cable 9 which protrudes from one end of the armored tubular cartridge 2.

The following describes the production process of an electric heater 1 in accordance with the invention.

In all the embodiments thereof, the process comprises the following steps:
providing at least one armored tubular cartridge 2 comprising at least one PTC resistor 3 therein;
overmolding by die-casting a block of aluminum 4, or alloys thereof, around said at least one armored tubular cartridge 2.

Advantageously, there is provided the application, for example by means of overmolding, of plastic material around said block of aluminum 4 to produce a coating layer 5.

1. An electric heater, comprising:
at least one armored tubular cartridge comprising at least one PTC resistor therein;
a block of aluminum, or alloys thereof, overmolded by die-casting around said at least one armored tubular cartridge;
wherein a coating layer in plastic material is provided, applied around said block of aluminum.

2. The electric heater according to claim 1, wherein said at least one armored tubular cartridge defines only a straight longitudinal axis X or only a curvilinear longitudinal axis.

3. The electric heater according to claim 1, wherein said at least one armored tubular cartridge comprises more than one stretch; wherein at least one first stretch defines a straight longitudinal axis and at least one second stretch defines a curvilinear axis.

4. The electric heater according to claim 3, wherein at least two first stretches are provided, preferably only two first stretches joined together by at least one second stretch, preferably by only one second stretch.

5. The electric heater according to claim 1, wherein said at least one armored tubular cartridge comprises at least two stretches; each stretch defining a respective straight longitudinal axis and wherein the straight longitudinal axes define a broken line.

6. The electric heater according to claim 5, wherein three stretches are provided.

7. The electric heater according to any claim 1, wherein a plurality of PTC resistors, preferably of ceramic material, are provided, connected in sequence to one another along the entire armored tubular cartridge.

8. The electric heater according to claim 1, wherein said at least one PTC resistor is inserted between two heat sinks or electrodes in aluminum, or alloys thereof, each aluminum heat sink or electrode being connected to a respective electrical supply cable which protrudes from one end of the at least one armored tubular cartridge.

9. The electric heater according to claim 8, wherein the an assembly, defined by said aluminum heat sinks or electrodes and said at least one PTC resistor, is surrounded by a layer of insulating material preferably powdered magnesium oxide or polyimide, externally bounded by a metal sheath, preferably in steel.

10. The electric heater according to claim 9, wherein the block of aluminum, or alloys thereof, is overmolded by die-casting around said metal sheath.

11. A production process of an electric heater according to claim 1, the process comprising the following steps:
providing at least one armored tubular cartridge comprising at least one PTC resistor therein;
overmolding by die-casting a block of aluminum, or alloys thereof, around said at least one armored tubular cartridge;
applying plastic material around said block of aluminum to produce a coating layer.

12. The electric heater according to claim 3, wherein only two first stretches are provided, joined together by only one second stretch.

13. The electric heater according to claim 1, wherein said at least one PTC resistor is made in ceramic material.

14. The electric heater according to claim 7, wherein said plurality of PTC resistors are made in ceramic material.

15. The electric heater according to claim 9, wherein said insulating material is powdered magnesium oxide or polyimide.

16. The electric heater according to claim 9, wherein said metal sheath is a steel sheath.
